(19) United States
(12) Patent Application Publication
(10) Pub. No.: US 2009/0224072 A1
(43) Pub. Date: Sep. 10, 2009

(54) HOSE END SPRAYER WITH MULTI-SIZE BOTTLE CONNECTORS

(75) Inventor: Michael T. Clarke, Grand Rapids, MI (US)

Correspondence Address: Waters & Associates, 161 Ottawa Ave., N.W., 305B WATERS BUILDING, Grand Rapids, MI, 49503, US

(73) Assignee: Root-Lowell Manufacturing Company, Lowell, MI (US)

(21) Appl. No.: 12/044,274

(22) Filed: Mar. 7, 2008

(51) Int. Cl. B05B 7/30; B05B 1/00

(52) U.S. Cl. 239/318; 239/581.1

(57) ABSTRACT

A hose end sprayer comprising a sprayer lid and container includes multiple bottle connectors formed of single-ended, fixed diameter, threaded sleeves of different radii mounted on the underside of the cap of the sprayer lid. The connectors allow the sprayer lid to be connected with containers having mouths of different sizes, including containers in which liquid chemicals are sold. A liquid conduit extends across the cap between a hose inlet on one end and a spray nozzle on the other end. A siphon tube intersects the conduit within the periphery of the smallest of the bottle connectors. The siphon tube carries liquid chemical from a container connected to the sprayer lid, such as a bottle of concentrated liquid, into the liquid conduit, where the liquid mixes with carrier water entering the liquid conduit at line pressure from an external hose connected to the hose inlet. The liquid carrier water mixture is then expelled from the nozzle.

### CROSS REFERENCE TO RELATED APPLICATIONS

None.

### BACKGROUND OF THE INVENTION

The present invention relates to a hose end sprayer having multiple bottle connectors mounted on the underside of the sprayer cap for attachment to different sized bottles.

A typical hose end sprayer for home and garden use comprises a liquid chemical dispenser that mounts on the end of a hose for dispensing a mixture of a liquid chemical and water from the hose. Typically, a hose end sprayer is employed with a generic or all purpose liquid container that is sold as a part of the product. The hose end sprayer comprises the liquid container and a sprayer lid comprising a cap that screws on the container, with a liquid conduit extending across the cap between a hose inlet and a nozzle outlet. A siphon tube extends downwardly from the conduit for drawing liquid chemical from the container into the stream of water that flows through the conduit from the hose inlet to the nozzle outlet.

To use a hose end sprayer, liquid chemical from a concentrate container is usually poured into the generic liquid container and sometimes mixed with water in the container to control the water/liquid chemical mixing rates. When the spraying is done, the remaining portion of liquid in the container is often either discarded or poured back into the supply bottle for the liquid concentrate. This promotes contamination and spills. Sometimes the remaining portion of the liquid is stored in the container, creating a question regarding the identity of the mixture at a later date because the container is not labeled with the manufacturer's product.

An object of the present invention is to provide an improved hose end sprayer to which, in addition to the generic bottle, concentrate bottles of different sizes can be directly attached, eliminating contamination, spills, and labeling problems common with current hose end sprayers.

### SUMMARY OF THE INVENTION

The present invention comprises a hose end sprayer comprising a sprayer lid having multiple bottle connectors of different sizes for connecting the sprayer lid to liquid chemical bottles of different sizes. The sprayer lid comprises a cap having a top and two or more annular bottle connectors extending downwardly from the top. The lid also includes a liquid conduit that extends across the lid from a hose inlet on one end to a nozzle outlet at an opposite end. A siphon tube extends downwardly from the liquid conduit from a position inside the periphery of the smallest connector to a lower end that is positioned to be in fluid communication with liquid chemical in the container. The siphon tube draws liquid from the container into the stream of water that flows through the liquid conduit from the hose inlet to the nozzle outlet. The bottle connectors desirably comprise multiple, single-ended, fixed diameter, threaded sleeves of differing radii mounted on the underside of the cap of the sprayer lid. The connectors are sized to be attachable the mouths of containers of different sizes, including containers in which the liquid chemicals are sold as well as a generic container provided with a conventional hose and sprayer.

Because the sprayer lid cap has multiple size bottle connectors, the lid can fit on the generic bottle that is sold with the sprayer, or it can connect on different size bottles in which the liquid concentrates are purchased. Thus, a liquid concentrate such as fertilizer or weed killer can be purchased from the store and screwed right into the lid of the hose end sprayer without first having to pour the liquid concentrate into the generic container. By doing this, when the spraying is complete, the liquid concentrate bottle can be unscrewed from the sprayer lid, and the sealing cap for the concentrate bottle can be screwed on for storage. Because the supply bottle is labeled with the manufacturer's product, there is never any problem or question about the identity of the contents of the sprayer bottle when spraying is through, and there is no need to pour the liquid back into the supply bottle, where contamination and spills are promoted. An adjustable mixing ratio valve is desirably incorporated in the lid for adjusting the mixing ratio of the liquid chemical and water. The sprayer is desirably actuated by a manual trigger valve incorporated in the sprayer lid.

### BRIEF DESCRIPTION OF THE DRAWINGS

FIG. 1 is a perspective view of the hose end sprayer showing the sprayer lid and containers of different sizes.

FIGS. 2A-2C are side elevational views showing the sprayer lid attached to a generic container and two liquid chemical containers having outlets of different sizes.

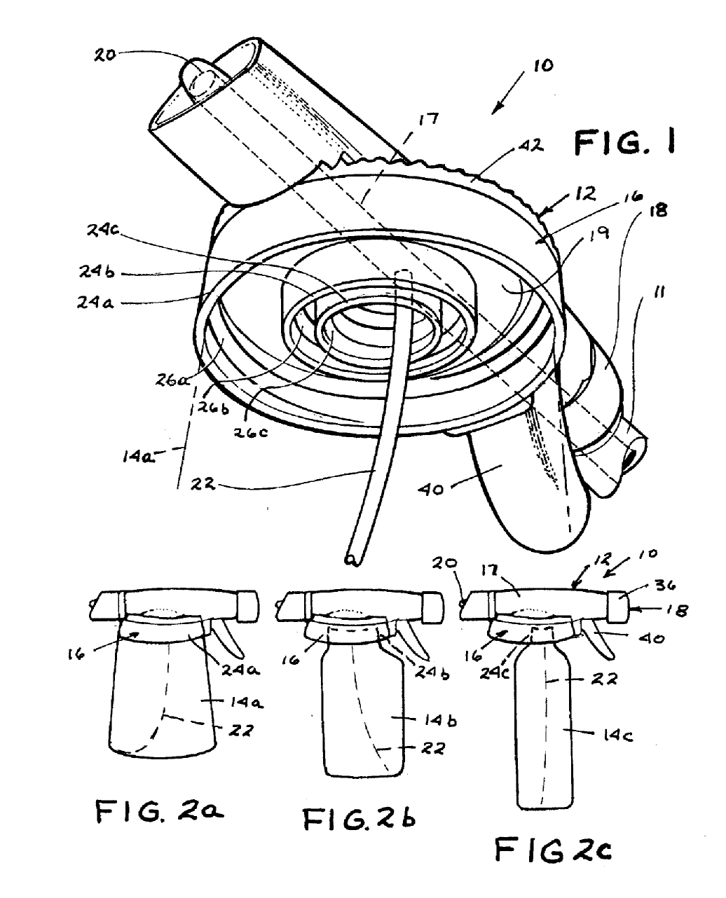

### DETAILED DESCRIPTION OF PREFERRED EMBODIMENTS

A hose end sprayer with multi-size bottle connectors 10 (hereinafter “sprayer”) is shown attached to an external garden hose 11. Other types of hoses also can be employed with the present invention.

Sprayer 10 comprises a lid 12 and container 14. The lid 12 comprises a cap 16, a transverse liquid conduit 17 having a hose inlet 18 and an outlet nozzle 20 at opposite ends, and siphon tube 22. Multiple, single-ended, fixed diameter, threaded sleeve bottle connectors of differing radii 24a, b, and c are mounted on the underside of the top 19 of cap 16 such that each bottle connector 24a-c is contained within the area defined by any of the bottle connectors 24a-c having a larger radius. The inner surface of each of the bottle connectors 24a-c has threads 26a-c to which the mouths 28a-c of containers 14a-c and other containers with threaded mouths can attach. The drawings depict a sprayer 10 having three bottle connectors 24, but the sprayer 10 could include more or fewer bottle connectors 24. The connectors desirably are formed as integral flanges on the underside of the top of cap 16, with the cap being molded from a synthetic resin and being substantially rigid. However, the connectors could be formed as separate caps, each having a top and a threaded peripheral flange, with the caps being stacked and fastened together to form a composite cap with multiple connectors.

The lid liquid conduit 17 desirably extends across the upper side of cap 16 so as not to interfere with connector threads 26. The hose inlet 18 connects to an external hose 11 such as a conventional garden hose using a threaded connector 36 or other hose connector that is connectable to the outlet of the hose.

Siphon tube 22 joins liquid conduit 17 within the area defined by the smallest bottle connector 24c, and thus is in position to communicate with all bottles that can be connected with the lid. The siphon tube 22 extends downwardly such that it extends to a lower end that is positioned adjacent the bottom of container 14 when container 14 is attached to lid 12. Desirably, siphon tube 22 is long enough to extend to the bottom of the tallest container used, but is flexible so that it can be used with shorter containers (see FIGS. 2A-C). Siphon tube 22 draws liquid chemical 38 from container 14 into water traveling through the liquid conduit from hose 11 so that a mixture of water and liquid chemical is expelled from nozzle 20.

The drawings depict a sprayer 10 having three bottle connectors 24a-c, but the sprayer 10 could include more or fewer bottle connectors 24. The sprayer 10 may also include a dial operated conventional flow control valve 24 to control the mixing ratio of liquid chemical to water in the mixed liquid sprayed from the nozzle. The sprayer 10 also includes a manually operated trigger valve 40 for convenient starting and stopping of water flow through the sprayer 10.

The foregoing is merely exemplary of the present invention, and various changes and modifications may be made in the arrangements and details of construction of the embodiments disclosed herein without departing from the spirit and scope of the present invention.

1. A hose end sprayer with multi-size bottle connectors comprising:
a lid including:
a cap having a top and two or more annular bottle connectors with different diameters positioned on an underside of the top;
a liquid conduit extending across the top, the conduit having an inlet at one end that is attachable to a hose and an outlet nozzle at an opposite end for discharging liquid; and
a siphon tube having an upper end connected to and in fluid communication with an interior of the conduit at a point inside of the periphery of the smallest bottle connector, the siphon tube extending downwardly from the upper end to a lower end, the siphon tube being formed such that liquid in communication with the lower end of the siphon tube is urged upwardly from the lower end through the upper end into the liquid conduit as a result of liquid flowing through the liquid conduit causing the admixture of liquid in the inlet conduit with liquid drawn through the siphon tube, with the admixed liquids being discharged from the outlet nozzle and a lower end positioned below the upper end; and
at least one liquid container adapted to hold a liquid chemical, the liquid container having an open mouth of a size and shape that mates with and is releasably attachable to one of the bottle connectors on the underside of the top, such that when the lid is mounted on the container and the container is filled with a sufficient quantity of liquid chemical that the liquid chemical is in communication with the lower end of the siphon tube, the liquid chemical is siphoned into liquid that is transmitted through the sprayer from the hose inlet to the nozzle, thereby causing admixed liquids to be discharged from the nozzle.

2. A hose end sprayer according to claim 1, wherein the liquid container comprises a bottle of a type that is customarily used to package and sell the liquid chemical, and the lid includes a bottle connector designed to fit on the mouth on that size of bottle, such that the lid can be attached directly to the liquid chemical bottle without having to first transfer the liquid chemical to another container for use with the sprayer.

3. A hose end sprayer according to claim 2, wherein the lid comprises at least two bottle connectors sized to be attached to liquid chemical bottles of two different sizes.

4. A hose end sprayer according to claim 3, wherein the lid further comprises a third connector sized for attaching a generic liquid chemical container to the lid.

5. A hose end sprayer according to claim 1 and further comprising a manually adjustable mixing valve that controls the ratio of liquid chemical and hose liquid discharged from the outlet nozzle.

6. A hose end sprayer according to claim 1 wherein the cap, with its top and connectors, is integrally molded from a synthetic resin and is substantially rigid.

7. A hose end sprayer with multi-size bottle connectors as in claim 5 wherein the cap includes a mixing valve controlled by a movable dial incorporated in the cap that regulates the proportions of liquid chemical from the container and liquid from the hose that are discharged from the sprayer.

8. A hose end sprayer according to claim 1 wherein the cap has a single top and the connectors are integrally formed therewith.

9. A hose end sprayer according to claim 1 wherein the bottle connectors each have a top and the connectors are stacked together and fastened together to form the cap.

10. A hose end sprayer according to claim 1 wherein the sprayer includes multiple containers of different heights and the siphon tube is flexible and long enough to extend to a position adjacent the bottom of the tallest container, the siphon tube being bendable so it also extends to the bottom of shorter containers.

11. A hose end sprayer according to claim 1 wherein the connectors are attached to an underside of the top of the cap.

12. A hose end sprayer according to claim 1 wherein the liquid conduit is positioned on the upper side of the top of the cap.

13. A hose end sprayer according to claim 1 wherein the lower end of the siphon tube is positioned so as to be in fluid communication with the interior of the container at a point adjacent the bottom thereof when the cap is attached to the container, the siphon tube being formed such that liquid in communication with the lower end of the siphon tube is urged upwardly from the lower end through the upper end into the liquid conduit as a result of liquid flowing through the liquid conduit, causing the admixture of liquid in the inlet conduit with liquid drawn through the siphon tube, with the admixed liquids being discharged from the outlet nozzle.
